(19) United States
(12) Patent Application Publication
(10) Pub. No.: US 2008/0168690 A1
(43) Pub. Date: Jul. 17, 2008

(54) Foldingly compactable V-shaped public event hand held sign display

(76) Inventors: Terry Lee Wagenknecht, Rockford, IL (US); Samuel James Wagenknecht, Rockford, IL (US); Charles Maxwell Wagenknecht, Rockford, IL (US)

Correspondence Address: TERRY LEE WAGENKNECHT, 6693 HEATHER LANE, ROCKFORD, IL, 61114, US

(21) Appl. No.: 11/983,597

(22) Filed: Nov. 9, 2007

Related U.S. Application Data
(60) Provisional application No. 60/879,978, filed on Jan. 11, 2007.

(51) Int. Cl. G09F 1/04

(52) U.S. Cl. 40/124.13

(57) ABSTRACT

A folding hand held sign display with discreet convenient transportable storage having instant pop-up communicative exposure is deployed in seconds with a flicking motion of a user's wrist. An elongate planar printable substrate of paperboard or plastic comprises a plurality of laterally directioned weakened hinge lines (20) to form a plurality of indicia panels (28) which foldingly abut each other in a compacted zig-zag or accordion like configuration to store within a pocket or handbag. A single weakened hinge line (22) parallels the substrate's elongate length to form a vertically upright and slightly V-shaped (42) form which is retained by a user's hand laterally squeezing the exterior edges until a release permits the substrate's return to a planar position for its re-folding into its pocket sized state. Alternative embodiments such as corrugated plastic support larger size displays with hinge forming partially through cut slits alternating on the substrate's two planar surfaces to retain its vertically upright position within any degree of and beyond its V-shape form.

### CROSS-REFERENCE TO RELATED APPLICATIONS

60/879,978—Provisional Jan. 11, 2007 Wagenknecht Folding Pocket Sign

### STATEMENT REGARDING FEDERALLY SPONSORED RESEARCH OR DEVELOPMENT

Not applicable.

### REFERENCE TO SEQUENCE LISTING

Not applicable.

### BACKGROUND

1. Field of Invention

This invention relates to an elongate slightly V-shape hand held sign display for a human user to hold upright during public events such as political rallies, sports events, and particularly golf tournament events; and to those displays which are compactingly foldable with a plurality of laterally directioned weakened hinge lines which traverse the substrate's width on one or both planar surfaces to form an accordion or zig-zag type of folding display for discreetly storing and transporting within a user's pocket, clothing placket, or handbag; and especially to those accordion type of folding displays which retain their vertical upright standing position with at least one vertically directioned weakened hinge line which perpendicularly intersects the laterally directioned hinge lines to form a slightly V-shaped structure.

2. Prior Art

Many public events require a need for a message to be displayed without obstructing the view of others. Political rallies often use hand held vertically elongate signs to display their candidate, home state, or party affiliation.

Sporting events such as golf tournaments need to display and announce to spectators when to be quiet. Volunteers usually stand within the spectators' view and raise a hand held sign to signal the crowd to be quiet as a golfer begins to concentrate on their stroke. Other sporting events include football, basketball, baseball games, etc.; where spectators may hold up hand held sign displays with various messages.

Hand held sign displays to be held upright at a public event are normally made from a semi-rigid paperboard or banner material. The displays are often in an elongate vertical size, so as not to completely inhibit another person's view. The displays are usually raised upwards in the air for a short time as the entire crowd stands and cheers when a score is made, or for a television camera's view.

Seating in an auditorium or stadium is rarely spacious enough for a spectator to simultaneously hold their sign display, and their food, and other personal items as they resume a sitting position.

Prior art searched did not disclose any hand held sign displays which allowed the display to be folded repeatedly for compact storage within a spectator's lap while sitting, or for the sign's transit to and from the event. No folding hand held sign displays were found which were foldingly compactable for placing into a user's pocket, or bag, or clothing placket; and most especially, none were found which regained their vertical standing stability with a flick of a wrist.

Prior art searched did not disclose any hand held sign displays which retained a vertically upright standing position using at least one bending hinge line(s) traversing the substrate's entire elongate length to form a slightly v-shaped structure.

### OBJECTS AND ADVANTAGES

Objects and advantages of this new concept of a foldingly compactable V-shaped public event hand held sign display are;

1. a compact and discreet storage and transport within a human user's pocket, or handbag, or clothing placket;
2. an instant two second unfolding and vertically upright assembly, and accomplished with only a flicking motion of a human user's wrist;
3. a retention of a display's vertical upright stability in windy conditions;
4. a display requiring only a single vertical weakened hinge line bend traversing the entire elongate height of the display to retain its V-shape vertical uprightness;
5. a display which may be alternatively manufactured with different materials, and using different methods of manufacturing, and in example;
i. a paperboard substrate with crimped weakened hinge lines formed via an offset, rotary, die-cut press, or folding machine, etc.;
ii. a polymer plastic substrate which may be injection molded;
iii. a co-polymer polypropylene corrugated plastic substrate which in the forming of its weakened hinge lines or its perimeter shape, may be hand-cut or slit, or machine cut or slit, or crimpingly impressed;
   6. a folding display which may be injected molded or laminated with an erasable marker type polymer plastic receiving surface for a human user to quickly vent their views repeatedly for a one-way or a two-way communication with others;
   7. a folding display which may either be decorated with or lettered with or indicia displayed with an electronic source of lighting;
   8. a folding display which may include bungee type elastic cords threaded through elongate flutes of a corrugated plastic for an instant one and a half second deployment;
   9. and a folding display which still retains its vertically upright standing stability with interior and or perimeter edge cut out portions of indicia art or logo shapes.

### SUMMARY

An elongate folding hand held display with discreet convenient transportable storage having instant pop-up communicative exposure within seconds comprises a generally planar, elongate indicia substrate which foldingly compacts into a human user's shirt or pants pocket, handbag, or clothing placket. A plurality of laterally directioned weakened hinge lines (20) extend across the shortest length of the elongate substrate, and perpendicularly intersect at least one directioned weakened hinge line(s) (22), (26) which is approximately centered and paralleling the elongate substrate's elongate length (22) to form a slightly V-shaped (42) display retained by a human user's hand. The display may be instantly deployed with a flicking motion of the wrist when a user chooses the vertically lowermost panel as a hand grip (30). When an elastic cord is threaded through a flute channel (44) aperture of one embodiment of corrugated plastic, the display automatically unfolds to assume a vertical position before the user slightly squeezes the substrate's lateral edges to retain the slight V-shape (42) configuration. Other embodiments may vary to accommodate erasable marker surfaces, injection mold manufacturing methods, or electronically lit perimeters or indicia and lettering, or perimeter edges which vary according to a logo's shape.

### BRIEF DESCRIPTION OF THE DRAWINGS

### Reference Numerals in Drawings

20 a lateral weakened hinge bend line perpendicular to the display's elongate length.
22. a vertical weakened hinge bend line parallel to the display's elongate length.
24. a hinge forming slit perpendicular to a corrugated substrate's elongate flutes.
26. a hinge forming slit parallel to a corrugated substrate's elongate flutes.
28. a panel normally reserved for indicia.
30. a panel optionally reserved for a user's hand-grip.
32. a diagonal fold line forming a tapered panel for a user's hand-grip.
33. a tapered panel for a user's hand-grip.
34. a notched panel for a user's hand-grip.
36. an aperture for retaining an elastic cord.
38. an elastic cord.
40. a chamfered area of a display's corner(s).
42. a display's slight alphabetical letter V-shape.
44. a corrugated plastic substrate's elongate flute channel (s).
46. a substrate's reinforcing thickness.

### BRIEF DESCRIPTION OF THE DRAWINGS

In the drawings, closely related figures may have the same number, but different alphabetic suffixes.

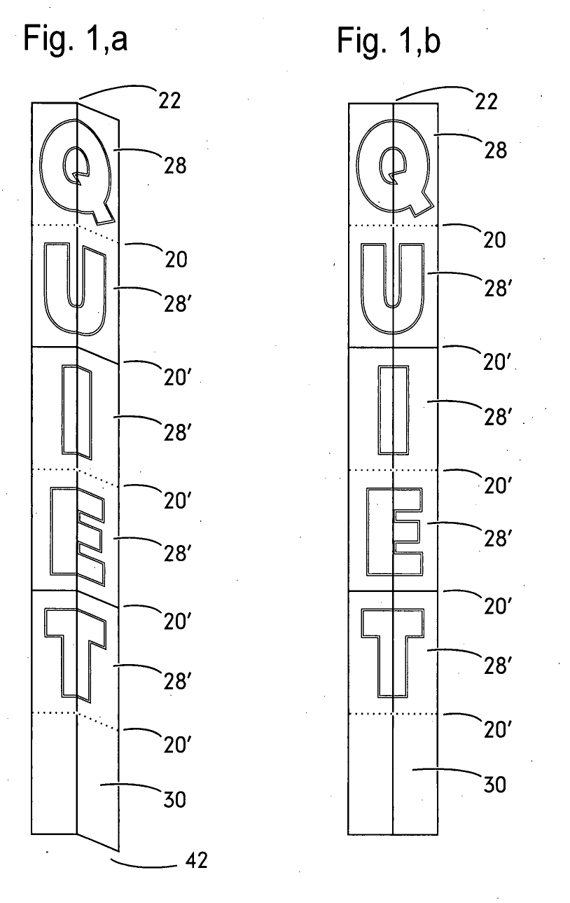

FIG. 1,a; A frontal and slightly perspective view of a preferred embodiment unfolded and positioned within the display's V-shape form.

FIG. 1,b; A frontal view of a preferred embodiment unfolded and in a flat and planar position.

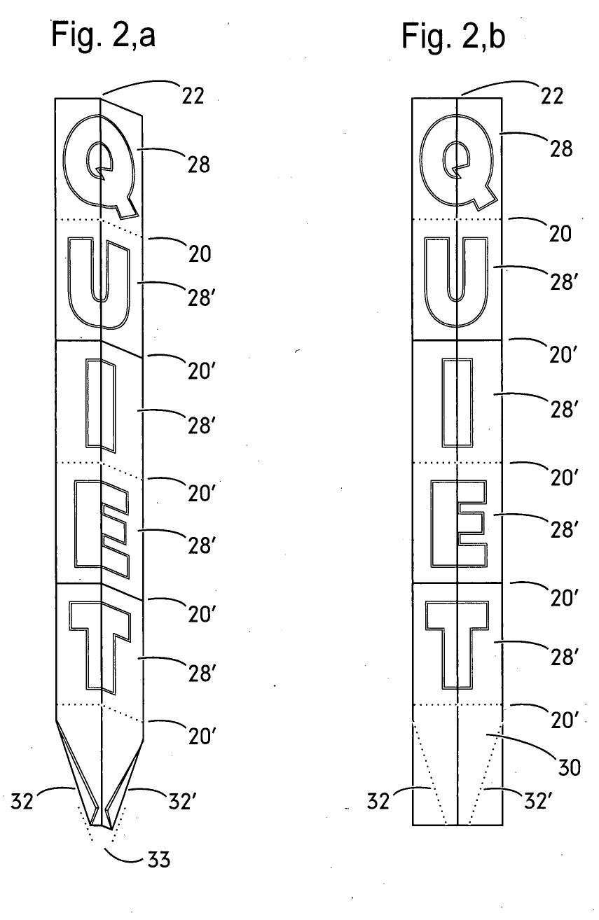

FIG. 2,a; A frontal and slightly perspective view of an alternative embodiment with fold lines forming a tapered hand grip, and showing the display being unfolded and positioned within the display's V-shape form.

FIG. 2,b; A frontal view of the alternative embodiment of FIG. 2,a, and being unfolded and in a flat and planar position.

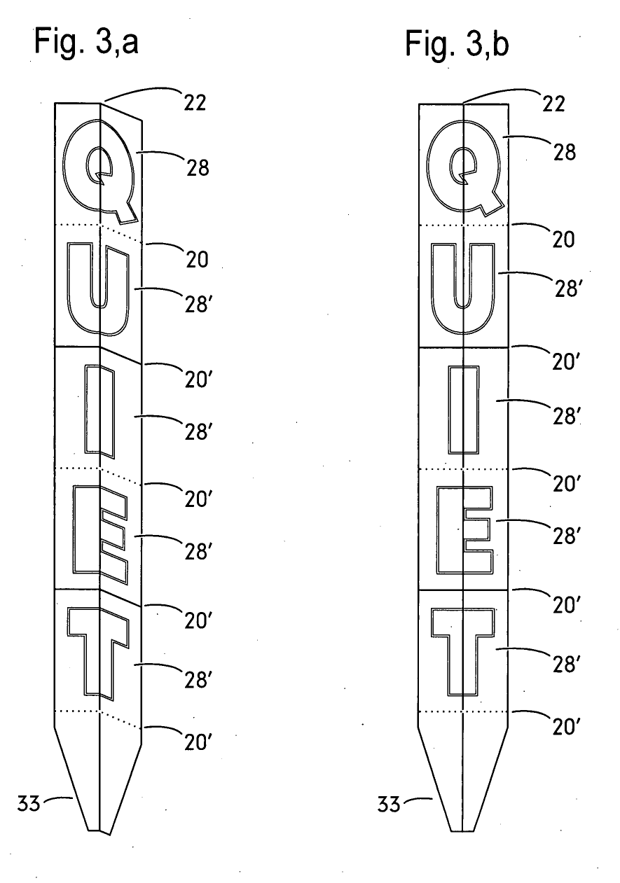

FIG. 3,a; A frontal and slightly perspective view of an alternative embodiment with cut away portions forming a tapered hand grip, and the display being unfolded and positioned within the display's V-shape form.

FIG. 3,b; A frontal view of the alternative embodiment of FIG. 3,a, and being unfolded and in a flat and planar position.

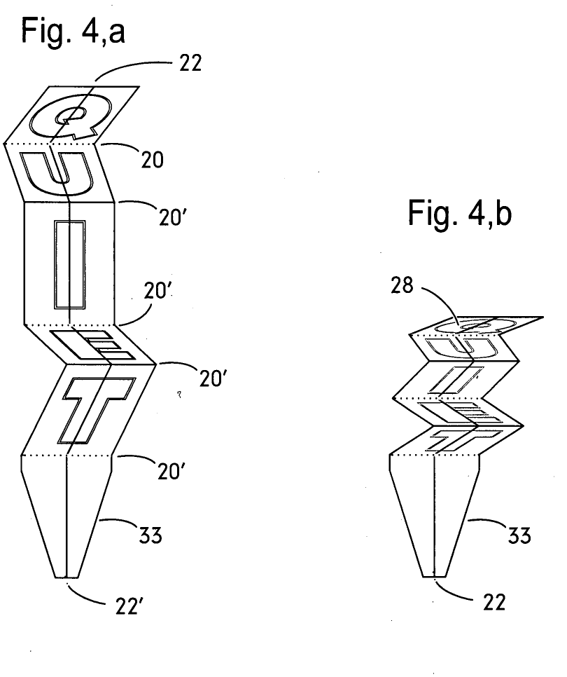

FIG. 4,a; A frontal and slightly perspective view of the alternative embodiment of FIG. 3,b with a tapered hand grip; and in a stage of being folded up.

FIG. 4,b; A frontal and slightly perspective view of the alternative embodiment of FIG. 4,a with a tapered hand grip; and in a stage of being further folded.

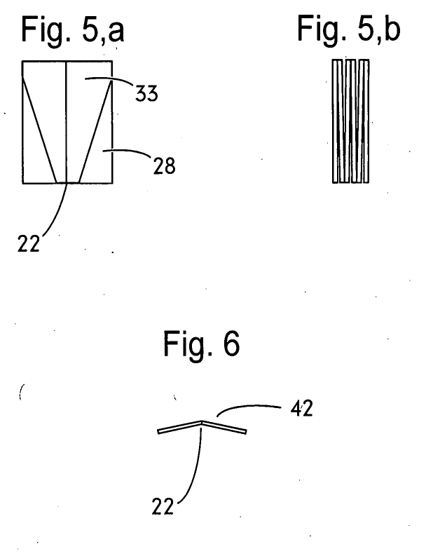

FIG. 5,a; A frontal view of the alternative embodiment of FIG. 4,a with the tapered hand grip; and in a stage of being completely folded up.

FIG. 5,b; A side view of the alternative embodiment of FIG. 5,a with the tapered hand grip; and in a stage of being completely folded up.

FIG. 6; An overhead view showing an assembled embodiment's slight V-shape.

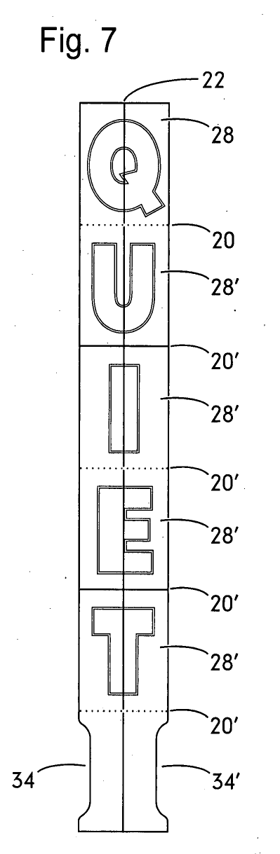

FIG. 7; A frontal view of an alternative embodiment including cut away notched portions forming a notched hand grip, and being unfolded and in a flat planar position.

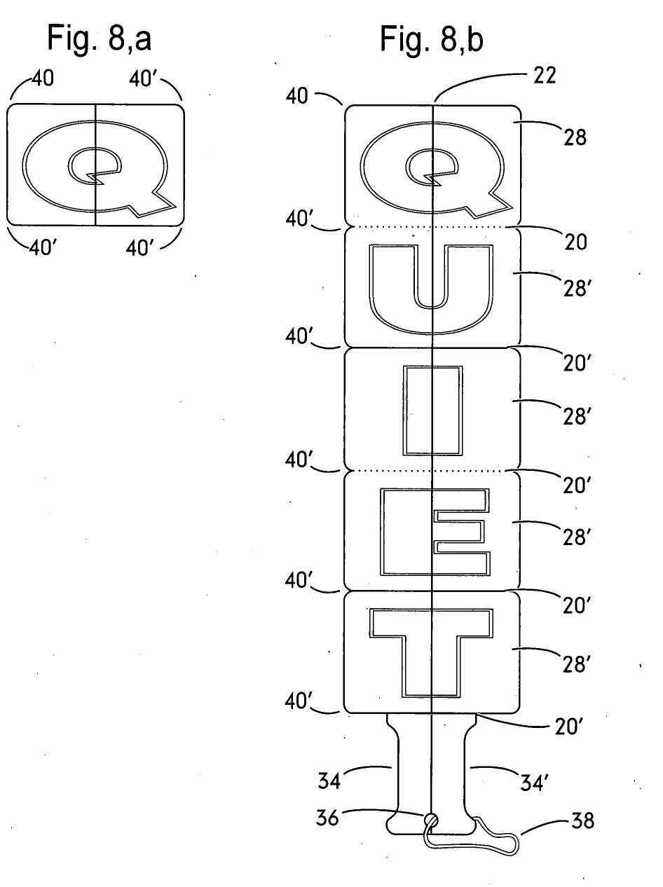

FIG. 8,a; A frontal view of an alternative embodiment, and being completely folded, and showing four chamfered corners, and being larger in width than any previous disclosed embodiments.

FIG. 8,b; A frontal view of the alternative embodiment of FIG. 8,a and shown completely unfolded and in a flat and planar position.

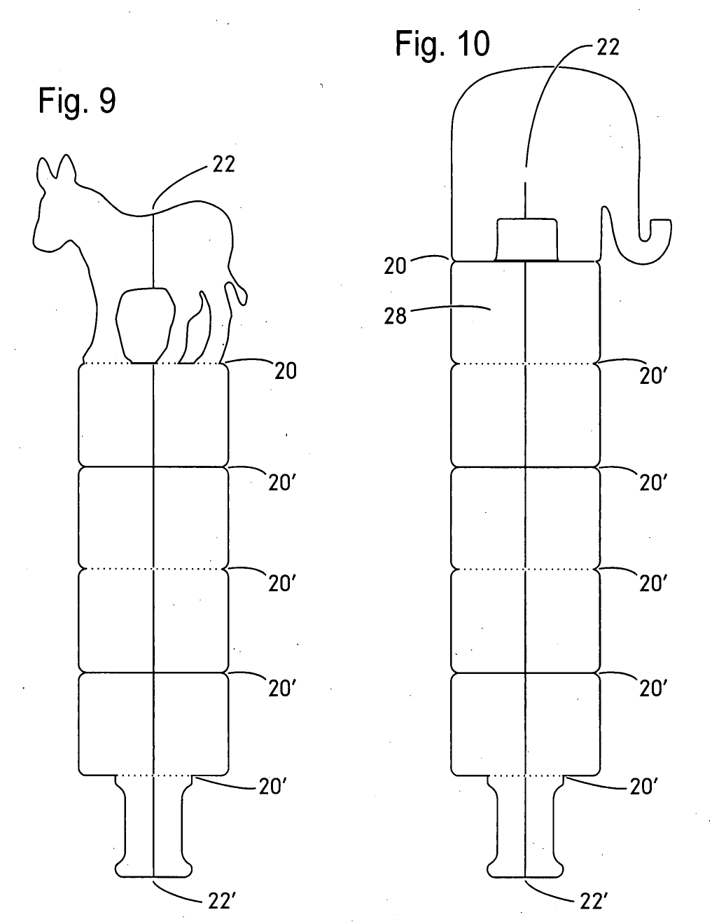

FIG. 9; A frontal view of an alternative embodiment and showing the substrate's perimeter edge cut away portions to match the indicia to be printed within; and shown completely unfolded and in a flat and planar position.

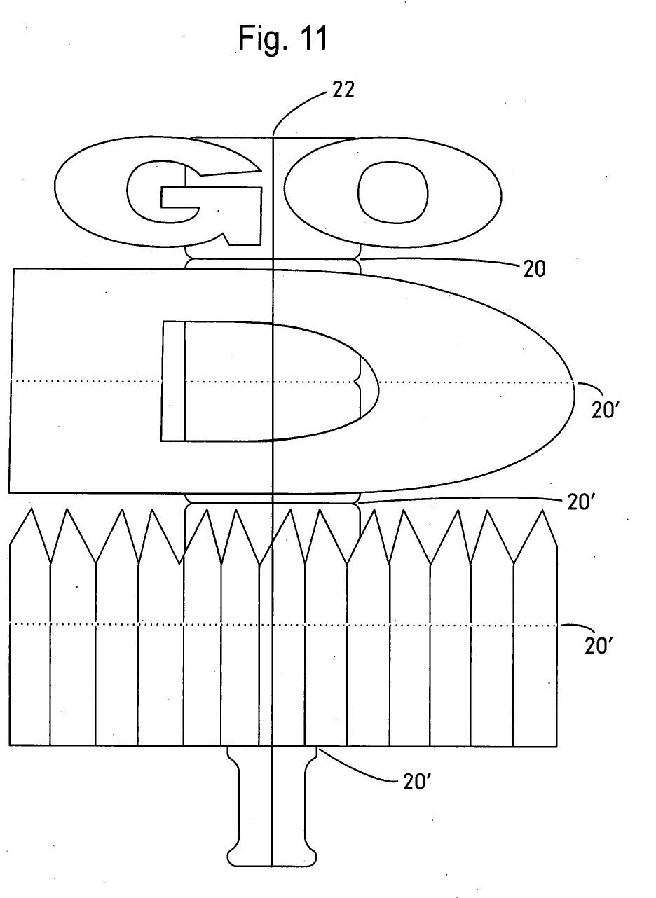

FIG. 10; A frontal view of an alternative embodiment and showing the substrate's perimeter edge cut away to match indicia to be printed within; and shown completely unfolded and in a flat and planar position, and showing an extra panel.

FIG. 11; A frontal view of an alternative embodiment of corrugated plastic, and showing the substrate's perimeter edge cut away to accommodate a much more larger and wider indicia area; and shown completely unfolded and in a flat and planar position.

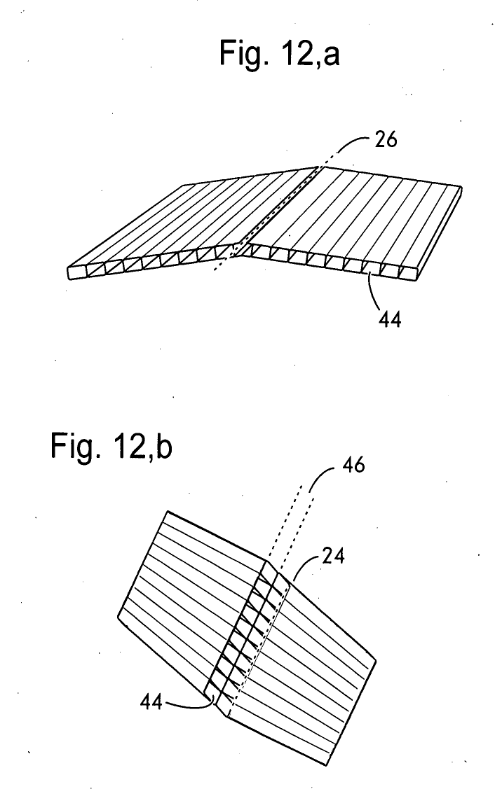

FIG. 12,a; A perspective view of corrugated plastic with a hinge forming slit which traverses parallel with the substrate's elongate flutes.

FIG. 12,b; A perspective view of corrugated plastic with a hinge forming slit which traverses perpendicular to the substrate's elongate flutes.

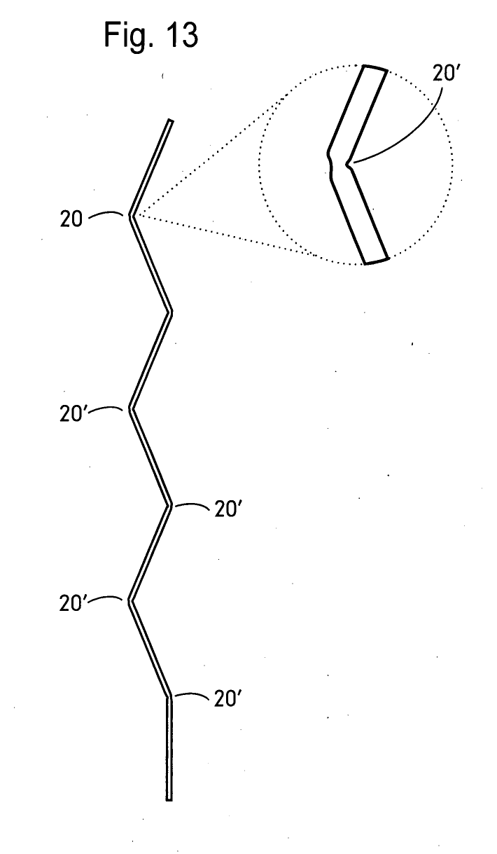

FIG. 13; A side view with a zoomed in view of a partially extended paperboard display.

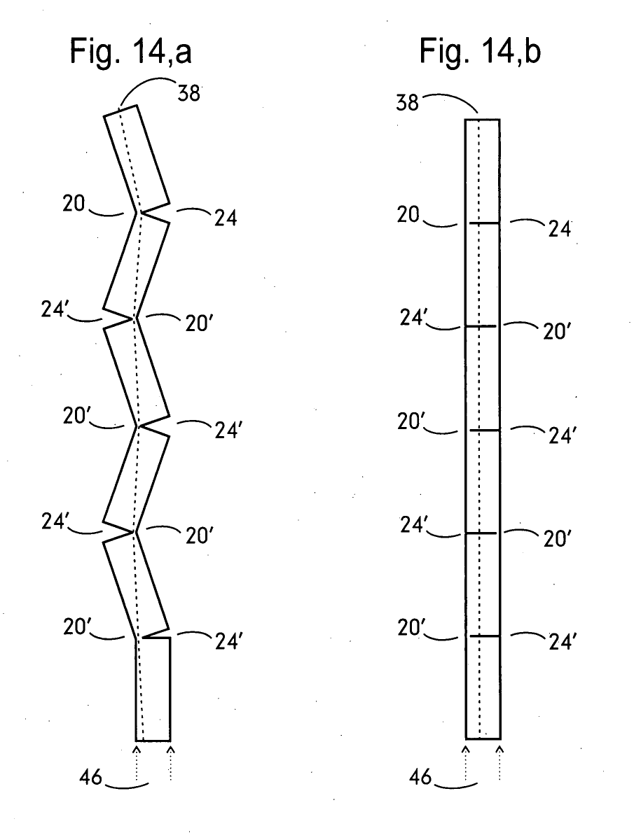

FIG. 14,a; A side view of a partially extended alternative embodiment display of corrugated plastic with an exaggerated thickness, and an elastic cord's location within.

FIG. 14,b; A side view of a fully extended alternative embodiment display of corrugated plastic with an exaggerated thickness, and an elastic cord's location.

### DETAILED DESCRIPTION OF THE DRAWINGS

### FIG. 1,a—Preferred Embodiment

The preferred embodiment of FIG. 1,a may be described as; an elongate generally planar substrate with approximate dimensions of 3 inches wide by 24 inches long by 1/16 inch or more thick, and comprising a plurality of laterally directioned weakened hinge bend lines (20) which traverse the substrates entire width. One centeredly located and vertically directioned weakened hinge bend line (22) perpendicularly intersects all said laterally directioned hinge lines, and parallels and extends the entire elongate length of the substrate. The elongate rectangular shape substrate may also be described as being in a vertically upright position with a slight alphabetical letter V-shape, (42) within the substrate's lateral width. Also shown are a plurality of indicia display panels (28), and one hand grip panel (30).

### DETAILED DESCRIPTION OF THE DRAWINGS

In the drawings, closely related figures may have the same number, but different alphabetic suffixes.

FIG. 1,a; A frontal and slightly perspective view of a preferred embodiment unfolded and positioned within the display's V-shape (42) form; and showing a plurality of lateral weakened hinge line bend (20) locations which are perpendicular to the substrate's elongate length, and one elongate weakened hinge line bend (22) location which is parallel to the substrate's elongate length, and a plurality of indicia panels (28), and a hand grip panel (30).

FIG. 1,b; A frontal view of a preferred embodiment unfolded and in a flat and planar position; and showing a plurality of lateral weakened hinge line bend (20) locations which are perpendicular to the substrate's elongate length, and one elongate weakened hinge line bend (22) location which is parallel to the substrate's elongate length, and a plurality of indicia panels (28), and a hand grip panel (30).

FIG. 2,a; A frontal and slightly perspective view of an alternative embodiment with a folded, tapered hand grip and formed by two diagonal weakened hinge bend lines (32), and showing the display being unfolded and positioned within the display's V-shape (42) form. Also shown are a plurality of lateral weakened hinge line bend (20) locations which are perpendicular to the substrate's elongate length, and one elongate weakened hinge line bend (22) location which is parallel to the substrate's elongate length, and a plurality of indicia panels (28), and two diagonal weakened hinge bend lines (32) forming a tapered hand grip (33).

FIG. 2,b; A frontal view of the alternative embodiment of FIG. 2,a, and being unfolded and in a flat and planar position; and also showing a plurality of lateral weakened hinge line bend (20) locations which are perpendicular to the substrate's elongate length, and one elongate weakened hinge line bend (22) location which is parallel to the substrate's elongate length, and a plurality of indicia panels (28), and a hand grip panel (30), and two diagonal weakened hinge bend lines (32) which when are not flattened, form a tapered hand grip.

FIG. 3,a; A frontal and slightly perspective view of an alternative embodiment with the display being unfolded and positioned within the display's V-shape form (42); and showing a plurality of lateral weakened hinge line bend (20) locations which are perpendicular to the substrate's elongate length, and one elongate weakened hinge line bend (22) location which is parallel to the substrate's elongate length, and a plurality of indicia panels (28), and cut away areas which form a tapered hand grip panel (33).

FIG. 3,b; A frontal view of the alternative embodiment of FIG. 3,a, and being unfolded and in a flat and planar position; and showing a plurality of lateral weakened hinge line bend (20) locations which are perpendicular to the substrate's elongate length, and one elongate weakened hinge line bend (22) location which is parallel to the substrate's elongate length, and a plurality of indicia panels (28), and a tapered hand grip panel (33).

FIG. 4,a; A frontal and slightly perspective view of the alternative embodiment of FIG. 3,b with the cut away tapered hand grip (33); and showing a plurality of lateral weakened hinge line bend (20) locations which are perpendicular to the substrate's elongate length, and one elongate weakened hinge line bend (22) location which is parallel to the substrate's elongate length, and a plurality of indicia panels (28), and a tapered hand grip panel (33); and in a stage of being folded up.

FIG. 4,b; A frontal and slightly perspective view of the alternative embodiment of FIG. 4,a, and showing an indicia panel (28), and the tapered hand grip panel (33); and in a stage of being further folded.

FIG. 5,a; A frontal view of the alternative embodiment of FIG. 4,a, and showing the one weakened hinge bend line (22) which parallels the elongate length of the substrate, and an indicia display panel (28), and the tapered hand grip panel (33); and in a stage of being completely folded up.

FIG. 5,b; A side view of the alternative embodiment of FIG. 5,a, and in a stage of being completely folded up.

FIG. 6; An overhead view of an assembled embodiment's slight V-shape (42), and showing a location of the single weakened hinge bend line location (22) which is parallel to the substrate's elongate length.

FIG. 7; A frontal view of an alternative embodiment including cut away areas forming a notched panel for a user's hand grip (34); and being unfolded and in a flat and planar position; and showing a plurality of lateral weakened hinge line bend (20) locations which are perpendicular to the substrate's elongate length, and one elongate weakened hinge line bend (22) location which is parallel to the substrate's elongate length, and a plurality of indicia panels (28).

FIG. 8,a; A frontal view of an alternative embodiment, and being completely folded, and showing four chamfered corners (40), and being larger in width than any previously disclosed embodiments.

FIG. 8,b; A frontal view of the alternative embodiment of FIG. 8,a and shown completely unfolded and in a flat and planar position, and showing the resulting indented areas of the chamfered corners (40) of FIG. 8,a; and also showing a plurality of lateral weakened hinge line bend (20) locations which are perpendicular to the substrate's elongate length, and one elongate weakened hinge line bend (22) location which is parallel to the substrate's elongate length, and a plurality of indicia panels (28); and also showing a notched hand grip panel (34), and an elastic cord retaining aperture (36), and an elastic cord (38).

FIG. 9; A frontal view of an alternative embodiment and showing the substrate's perimeter edge cut away portions to match the indicia to be printed within; and shown completely unfolded and in a flat and planar position; and also showing a plurality of lateral weakened hinge line bend (20) locations which are perpendicular to the substrate's elongate length, and one elongate weakened hinge line bend (22) location which is parallel to the substrate's elongate length.

FIG. 10; A frontal view of an alternative embodiment and showing the substrate's perimeter edge cut away to match indicia to be printed within; and shown completely unfolded and in a flat and planar position; but showing an extra indicia panel (28) to further explain to the viewer that this folding V-shape sign is not dependent on any particular number of panels, other than a materials' type and strength for its vertical and V-shape stability. Also note the vertical and shortened weakened hinge line (22) in the uppermost indicia panel to give a user the final option of hand crimping the uppermost panel for further control of the panel's degree of V-shape and prevention of indicia distortion.

FIG. 11; A frontal view of an alternative embodiment of corrugated plastic, and showing the substrate's perimeter edge cut away to accommodate a much more larger and wider indicia area; and shown completely unfolded and in a flat and planar position; and showing a plurality of lateral weakened hinge line bend (20) locations which are perpendicular to the substrate's elongate length, and one elongate weakened hinge line bend (22) location which is parallel to the substrate's elongate length.

FIG. 12,a; A perspective view of a corrugated plastic's material with a hinge forming slit (26) which runs parallel with the substrate's elongate flutes, and also showing one of the many flute openings (44).

FIG. 12,b; A perspective view of a corrugated plastic's material with a hinge forming slit (24) which runs perpendicular to the substrate's elongate flutes, and also showing one of the many flute openings (44), and the material's reinforcing thickness (46).

FIG. 13; A side view of a partially extended paperboard display with weakened hinge bend lines (20) which are perpendicular to the display's elongate length; and also showing a zoomed in view of a paperboard's crimped portion of the bend line; and purposed to show a lack of the material's reinforcing thickness as disclosed in FIGS. 14,a and b.

FIG. 14,a; A side view of a partially extended alternative embodiment of a corrugated plastic display with weakened hinge bend lines (20) which are perpendicular to the display's elongate length, and also hinge forming slit (24) locations which are perpendicular to a corrugated substrate's elongate flutes direction and including an exaggerated thickness of the corrugated substrate, and an elastic cord's (38) location within; and while under tension; and purposed to disclose a corrugated material's reinforcing thickness (46), or alternatively and comparatively as an injection molded plastic material's reinforcing thickness.

FIG. 14,b; A side view of an alternative embodiment of a corrugated plastic display as in FIG. 14, but fully extended; and showing the same hinge lines (20), and the same slit locations (24); and including an exaggerated thickness as in FIG. 14,a, and an elastic cord's (38) location within, and while under tension; and purposed to disclose a corrugated material's reinforcing thickness (46); and while not showing any of the cord's tie-off knots.

### DETAILED DESCRIPTION OF THE DRAWINGS

### Operation

In forming a V-shape sign display, a manufacturing user may choose their type of substrate according to the message, or the type of event the display is purposed for, or whether the event is held indoors or outdoors, or the degree of a display's repeatable use, or the overall size. The substrate may be of a paperboard, or an injection molded polymer plastic, or a light weight polyethylene or polypropylene plastic sheet, or a corrugated co-polymer plastic sheet, or any printable material which may repeatedly bend without immediately fracturing.

When using a light paperboard, any weakened hinge lines may be crimped from rules within a rotary or offset press, or a folding machine. When using a heavier paperboard or plastic sheet, steel rule die cutting may cut the outer perimeter shape and crimp the weakened hinge lines simultaneously. When using a polymer plastic, an injection mold process may form the outer shape, and also form any weakened hinge lines by lessening material mass within their locations.

When using a corrugated plastic sheet substrate, weakened hinge lines may may be made by hand or machine crimping when the lines parallel a substrate's multiple elongate flutes. A weakened hinge line may also be made by slitting one surface of the material; and wherein the material's opposite planar surface will serve as a hinge; see FIG. 12,a. Any said lines which are perpendicular to the elongate flute's directions must be made using hinge forming slits; see FIG. 12,b. The direction of the corrugated material's elongate flutes according to the elongate display's elongate direction is a matter of a manufacturer's choice, and dependent only on the method chosen to make the display, and the final size of the display, wherein a larger display might stand more rigid when the flutes are vertical and perpendicular to the ground when the display is held by a user.

FIG. 1,a shows a paperboard embodiment with a plurality of lateral weakened bend lines (20) which are perpendicular to the display's elongate length, or parallel to the ground when held upright by the user. The quantity of lateral bend lines made are a matter of choice, yet with less than two or three bends, the folding display's purpose would be lost, as the display would be too large to fit in a pocket.

Only one weakened hinge line (22) which parallels the display's elongate length is necessary to retain the display's vertical uprightness via the display's slight V-shape (42) as seen in FIG. 1,a. Any printed indicia may fit within the indicia panels (28) and between the weakened hinge line (20) locations, or may be printed over all weakened hinge lines. The panel chosen for a user's hand grip in FIG. 1 (30) may also be in a tapered hand grip (33) as in FIG. 2,a; and formed via two diagonal weakened hinge bend lines (32). The tapered hand grip (33) may also be formed by cutting the material away at the diagonal line (32) locations as in FIG. 3,a (33).

After all weakened hinge lines are formed, the display will bend in a zig-zag form as shown in various stages of folding within FIGS. 4,a and 4,b for folding compact to fit in a shirt or pants pocket. When a user is ready to display their message, they may pull the display from their pocket, and then grip the tapered handgrip panel (33), and then flick their wrist outward and away from their body, and when the display's most distal panel unfolds, quickly but gently squeeze the handgrip panel (33) until the display forms a slight V-shape (42). This is more easily done when a user flicks the display toward the ground, but may take a few practice tries to proficiently deploy the display skywardly.

A folded display within a user's pocket becomes a vertical and upright indicia display within approximately 2 and ½ seconds, or basically in an instant. Re-folding and re-inserting into the pocket takes longer; and which is about 3 and ½ seconds.

Sporting events such as golf tournaments may involve up to 100 people or more who hold up quiet signs as a golfer begins their stroke. As a display may be unfolded so quickly, a user needs to use some discretion in its deployment, as to not distract a spectator's or golfer's attention.

FIG. 5,a is a frontal view of a completely folded display to show a tapered hand grip (33), a paralleling to the substrate's elongate length weakened hinge line (22), and an indicia display panel. FIG. 5,b is a side view of FIG. 5,a to show a display's compactness. FIG. 6 discloses the slight V-shape (42) of the display from an over head view, while also disclosing the paralleling hinge line's (22) location.

FIG. 7 shows an alternative embodiment with cut away areas which form a notched hand grip (34). The notches may also be formed with laterally cut through slits which come in from each side's edge to form tabs which fold inward; and as this method of notch forming is not very aesthetic, art was not made. The notch formed projections located within the most lower panel of the display in FIG. 7, (34) help a user to better grip a display under wet conditions of rain or sweaty hands.

An average shirt or pants pocket size will accommodate a display with a folded and approximate dimension of up to 1 and ½ inches thick by 3 inches wide by 4 and ½ inches long. This equals about 5 indicia panels (28) and 1 hand grip panel (30); and where pocket dimensions vary in exact size, so may the size of the overall display. These dimensions cited are from a display made of corrugated plastic with a planar thickness of approximately 3/16 inch or less. A co-polymer plastic of polypropylene or a polyethylene material in a thinner material thickness will work fine also. The corrugated substrate has been described by at least one manufacturer as a living hinge; and with the ability to be bent thousands of times at 72 degrees Fahrenheit.

A folding display which needs to be seen from a greater distance may be larger; and may be stored in a purse, or bag, or a sweat shirt's front pouch pocket, or clothing placket; or in any containment larger than a human's shirt pocket or pants pocket. FIG. 8,a and FIG. 8,b are two views of a slightly larger size display.

FIG. 8,a is a front view of an alternative embodiment's completely folded display, and showing all four corners which have been chamfered. Chamfers may be formed by hand, or machine die cut with many of the materials disclosed.

FIG. 8,b is a frontal view of FIG. 8,a, and after the display has been completely unfolded, and shows several chamfered corners (40) and how they appear after the display's unfolding. Rounded corners help to prevent a display from snagging a user's skin or clothing. Note the cut away areas which form a notched handgrip (34), and an aperture (34) for retaining an elastic cord (38). The cord may be similar to a ponytail hair retainer cord, and is purposed to wrap around and retain a folded display. The single weakened hinge line (22) which parallels the display's elongate length is shown; as well as several lateral and perpendicular to the display's elongate length weakened hinge lines (20). Every other lateral hinge line (20) is shown in a dotted line to remind the viewer of the zig-zag bend configuration, and especially when the weakened hinge lines are formed with partial through cut slits which result in hinges located alternately on a corrugated substrate's two opposite planar surfaces. Hinge forming slits are shown in FIGS. 12,a and b; and with a display's complete hinge forming slits configuration shown in FIGS. 14,a and b.

Note how the indicia panels (28) in FIG. 8,b are much wider in respect to a width of the notched hand grip (34), and also wider than any indicia panels previously disclosed. A display's size is relative to a manufacturer's end use message or purpose, and its predetermined folded size to fit within a chosen storage space.

When a display is designed for specific art or logos, the substrate's outer perimeter edge or interior may be machine die cut without obstructing a display's function of standing vertically erect within the standing V-shape, or its foldability. FIG. 9 and FIG. 10 illustrate how two very different images may be incorporated within a display's perimeter edge; and without limiting its foldability, other than the very uppermost panel's size. This uppermost panel could be smaller to match the display's width, but would lose some of its visual impact as a graphic not extending beyond the display's width. Note an extra rectangular indicia panel within FIG. 10 to show a viewer that the display is not dependent on a specific number of panels.

Also note; the vertical weakened hinge line (22) of FIG. 10 does not extend to the uppermost indicia panel's very exterior upper edge. When some indicia forms are viewed from a slight angle, the indicia may become distorted as a user holds a display with too much of a degree within the hand held V-shape. In this comparison between FIG. 9 and FIG. 10, a manufacturer as within FIG. 10 may decide to help eliminate any chance of another viewer seeing any slight distortion of the image, and so shorten the line (22). A user may then hand crimp the very uppermost indicia panel to their discretion for the display's standing stability. Any standing stability is also dependent on the material substrate's type; and where a corrugated plastic of at least 3/16″ provides a thicker material which further aids the display's stability; and especially when the very uppermost indicia panel is not as fully V-shaped as all the other panels located vertically beneath it. See FIG. 14,a,b (46).

FIG. 11 is a frontal view of an alternative embodiment's more detailed graphical display, and is purposed to show the viewer how detailed graphics, and including cut away portions within the display's interior may form the folding indicia display panels; and without the panels having to be rectangular in shape. This display's approximate size is 18 inches in one direction, and might require a corrugated plastic substrate of approximately 3/16 inches in thickness.

The majority of sports stadiums within the continental U.S. do not allow any hand held sign displays which are attached to a stick or rod. Sign supporting sticks or rods may become accidental weapons. This display is in part, purposed to function as a sign elevating stick or rod without being one. Preferred materials disclosed are soft enough to be repeatedly bent without immediately fracturing, and yet are not strong enough to be considered a weapon, such as a stick or rod.

Some stadiums also have a size regulation of 18 inches maximum for a hand held sign display. The larger size embodiment of FIG. 11 will still fold to a compact size of 4 and ½ inches by approximately 16 inches for convenient storage within a spectator's lap or the front hand pouch of a hooded sweat shirt type jacket, until the next opportunity to stand, cheer, and instantly unfold the display in the air.

It is naturally preferable to use a thicker substrate when forming a larger display as shown in FIG. 11, and such as with an alternative embodiment of corrugated plastic as shown in FIG. 12,a and FIG. 12,b, (46). Note the hinge forming flute paralleling slit (26), in FIG. 12,a, and note the open gap between the two resulting flaps of what was the entire four-walled flute structure. After the hinge forming slit (26) is made, the resulting flaps are flexible enough to overlap one another as the substrate bends at the newly formed hinge's location. And so, if the corrugated flutes direction is parallel to the ground within this embodiment, at least some degree of rigidity or standing stability would be lost.

Compare FIG. 12,a to FIG. 12,b; where in FIG. 12,b a hinge forming slit (24) is made perpendicular to a flute's direction; and wherein all the newly made flute openings (44) will abut each other when the material returns to a completely planar and unfolded position. As a user laterally squeezes the substrate's two exterior edges, or the hand grip's exterior edges, each lateral half of all the indica panels uniformly bend inwardly from the centeredly located single weakened hinge bend line (22) location to form a slight V-shape (42).

The corrugated flutes' direction in a larger sized display should be perpendicular to the ground, and when the display is held vertically upright. The weakest portion of the display in FIG. 11 is the location where the hand grip (34) hingedly joins the first and lowermost connecting indicia panel. It is at this location where any small degree of vertical standing stability is even more important, and especially within the larger sized display as in FIG. 11.

See a side view illustration in FIG. 13 of a plastic coated paperboard substrate which is partially unfolded, and extending vertically upward, and showing a plurality of lateral and perpendicular to the display's elongate length weakened hinge line (20) locations. Note the substrate's thickness, or lack of thickness to aid in its standing stability. Also note the zoomed in area to show where the substrate's thickness has been comparatively unevenly crimped to form the weakened hinge lines (20), and so results in slightly less standing stability for a larger sized display.

See the side view illustration in FIGS. 14,a,b; where one embodiment in FIG. 14,a is partially extended vertically upwards, and with the same embodiment shown in FIG. 14,b in a fully extended position, and before any lateral squeezing of the substrate's edges to form the slightly V-shape. These two alternative embodiments of corrugated plastic are slightly exaggerated in their reinforcing thickness (40) to better illustrate the support which the corrugated material has when using the perpendicular to a flute's direction hinge forming slits (24), and as shown fully extended in FIG. 14,b. Resulting hinge line (20) locations are also shown.

Notice in FIGS. 14,a and 14,b how the slit formed hinge locations alternate upon opposite planar surfaces of the substrate to allow for its compact folding. This procedure of placing every other hinge forming slit (24) on one planar surface is only necessary when using a thicker alternative substrate such as corrugated plastic, or a thicker and multi-ply paperboard. Normally, the single ply paperboard of FIG. 13, is approximately 0.040, or forty thousands inch thickness or less, would only require weakened hinge line (20) crimpings to be made on only one planar surface. As the paperboard material is so thin, any bends will easily form first at the crimped weakened hinge line locations, and so allow easy compacting to fit within a pocket.

When a manufacturer needs a folding display to unfold faster than the previously stated 2 and ½ seconds, they may add a bungee type of elastic cord(s) (38) of an appropriate thickness which threads through one or more of a corrugated substrate's flutes. The cord is then tightened to the maker's desired springiness and then tied off in any manner chosen. The preferred flute direction in an elastic cord(s) tensioned display parallels the single weakened hinge line (22) and the contained elastic cord (38); and is perpendicular to the ground as a user retains the vertically elongate and slightly V-shaped display. Tests made have reduced deployment from 2 and ½ seconds to approximately 1 and ½ seconds or less. FIGS. 14,a and 14,b (38) show one cord's location, and with any tie-off knots not being shown.

Note how the wall's thickness (46), and the stretched elastic cord (38) within, will retain the display in a vertically upright position. This vertical standing position will remain until a slight wind, or a slight motion of a user's hand upsets the balance between the hinge point locations (20) and the retained and tightened elastic cord.

The slight V-shape (42) which is not shown in the drawings of FIG. 14,a,b; will retain the upright position in a heavy wind, or with extreme motions of a user's hand.

The elastic cord(s) deployed embodiment does make some clacking noise as the panels unfold, and so would not be recommended for use as a quiet sign within a golf tournament. All other previous embodiments which unfold with a flick of a user's wrist are very quiet and noise free as their indicia panels quickly unfold.

Concerning previous embodiments without an elastic cord (38) and those embodiments comprising a reinforcing thickness (40) and the defined alternating hinge locations upon opposite planar surfaces have an additional advantage.

As a display holding, V-shape retaining user gets increasingly excited over details within a sports event, the motions of the hand tend to increase also. As an excited user's hand motions increase, their hand's degree of tensioned grip tends to increase, and accordingly so does the degree of the display's V-shape.

Within this scenario of excitement, a display will remain standing vertically upright or near to vertically upright when using alternative embodiments of corrugated plastic or similar thick substrates which use the defined alternating hinge locations upon opposite planar surfaces as described in FIG. 14, a and b; or alternating hinge locations upon opposite planar surfaces formed via said less material in the previously described injection molded process of polymer plastic.

All embodiments using crimping means to form the lateral weakened hinge lines will retain an upright position as the display's slight V-shape increases inwardly, but when the indicia panels fold laterally enough for the panels to abut themselves, any one of the previously V-shape hinge lines will stressfully merge into one hinge; and wherein the display may fold over at the first said merging.

Embodiments with a reinforcing thickness (40) and formed with the defined alternating hinge locations upon opposite planar surfaces will remain upright when indicia panels of a V-shape fold laterally enough for the panels to abut themselves. The hinge lines may be invertedly facing or touching each other; yet the substrate's thickness acts as an abutment(s) to prevent the substrate's bending or folding.

The display may temporarily be no longer visible as a message, yet the display is still standing throughout; and continually as a user relaxes their hand to return to the slight V-shape to regain the message's visibility.

This embodiment stands on its own during the more exciting times of its use, and will not flop over to strike an adjacent spectator. This small merit of a thicker substrate with alternating planar surface weakened hinge lines becomes very important when the spectator next to a user is big enough to be playing on the field.

A manufacturer or a user also has an option of applying an adhesive vinyl with an erase-able marker type receiving surface on one or both planar surfaces of any substrate's chosen material type. The erase-able marker surface may be applied to the display in areas between any weakened hinge lines, or the entire polymer plastic substrate may be of a plastic which has the wipe-off properties of an erasable surface. This option of an end user being able to write their own copy on at least one, or both surfaces of the display opens up unlimited markets within many categories such as an emergency use in directing crowds and traffic or signaling for help from a stalled vehicle, etc. New markets of zealous sports fans who could not yell loud enough to vent their views during a game may now do so in a different way.

### CONCLUSION, RAMIFICATIONS, AND SCOPE

LED technology is also one of the many ways of producing communicative indicia; and just as an erasable marker, or printed matter, etc.; and is understood to be all inclusive within this new concept of a hand held folding sign display.

LED light emitting diode enhancement of a display's perimeter edges will help light a display's indicia for night time viewing; as well as being an LED indicia source within the indica panels themselves. Technologies are advancing to smaller and thinner LED panels each year. This alternative embodiment may require a slightly larger pocket or purse or handbag for a discreet storage and transport. Artwork is not shown, as the technology will advance far beyond anything which could be drawn; and especially by the time this disclosure is fully evaluated. Connecting ribbon type flexible wires may form or traverse the weakened hinge lines; and with electronics and/or the power supply being contained within the handgrip portion.

All types of useable substrate materials are not disclosed in the drawings; and including light weight paperboard laminated with colored vinyls, or light emitting diode LED electronically lit display configurations, or liquid crystal LCD electronically lit displays, or the multiple ways of threading and tying off elastic cord deployment configurations, or an erasable marker type surface, or attached team flags or symbols and such enhancements; as they shall be deemed all inclusive within a manufacturer's options of forming a decoratively enhanced foldingly compactable V-shaped public event hand held sign display.

Various types of treated paperboard shall also be deemed all inclusive; and including those such as plasticized paperboard, or plastic impregnated paperboard, or plastic laminated paperboard, or vulcanized paperboard; and including multilayer or multi-ply paperboard, and any type of paperboard which has been printed or is printable, and of which is repeatedly bendable without fracturing.

Accordingly, the reader will see that the scope of this new concept of a foldingly compactable V-shaped public event hand held sign display goes beyond it's many advantages over previous hand held sign displays;

wherein a sports fan may discreetly and comfortably carry their message to their assigned seat within a stadium, and instantly and repeatedly unfold their display at their discretion. This application does not disclose the V-shape structure as any type of fixed signage structure, but specifically and only as a hand held unfoldable display which is specifically intended for storage within a human user's clothing pocket, clothing placket, or handbag.

The display's resulting overall dimensions are interdependent on a manufacturers intended purpose of message, and also the type of event chosen, and an intended profit margin, and a resulting substrate's material type chosen; wherein a material's substrate composition, or any overall dimensions, or its perimeter shape, or its coloring of background or lettering are all inclusive within the scope of this new concept of a foldingly compactable V-shaped public event hand held sign display.

As in the claim one of the original provisional application No. 60/879,978, and generally stating; where at least one longest hinge bend line intersects a plurality of other and shorter bend lines, it has been the initial inferred intent that, the words at least one; do not restrict a plurality of longest hinge bend lines, and although no drawings were initially created to depict the concept, the concept still remains.

The primary goal of this new concept of a foldingly compactable V-shaped public event hand held sign display is summarily; to provide a hand held display with discreet convenient transportable storage, and having instant pop-up communicative exposure within seconds.

Although previous descriptions contain many specificities, these should not be construed as limiting the scope of the invention but as merely providing illustrations of some of the presently preferred embodiments of this invention.

1. a hand held indicia display comprising;
an elongate generally planar substrate,
a plurality of hinge bend lines,
wherein a first portion of said hinge bend lines (20) extend a shortest dimension of said substrate,
to form a plurality of indicia panels (28),
and wherein any said panel functions as a hand grip panel,
and wherein a second portion of said hinge bend lines (22) is approximately centeredly located within said substrate to extend a longest dimension of said substrate, and perpendicularly intersecting said first portion,
whereas said substrate adapts to a slight alphabetical letter V-shape (42)
wherein said slight V-shape securely retains a standing structural stability of said substrate,
and whereas said substrate additionally adapts to a folded compacted shape for transportable storage.

2. a display as recited in claim 1, and further comprising
a tapered hand grip located at one distal end of said display.

3. a display as recited in claim 1, and further comprising
chamfered corners.

4. a display as recited in claim 1, and further comprising
a retaining cord to further secure a folded said display.

5. a display as recited in claim 1, and further comprising
a paperboard material.

6. a display as recited in claim 1, and further comprising
a laminated paperboard material.

7. a display as recited in claim 1, and further comprising
a polymer plastic material.

8. a display as recited in claim 7, and further comprising
a corrugated plastic sheet.

9. a display as recited in claim 7, and further comprising
said first portion of said hinge bend lines being alternately located on opposite planar surfaces of said display to cooperate with a reinforcing thickness of said display to further secure a standing stability of said display.

10. a display as recited in claim 8, and further comprising
said first portion of said hinge bend lines being alternately located on opposite planar surfaces of said display to cooperate with a reinforcing thickness of said display to further secure a standing stability of said display.

11. a display as recited in claim 10, and further comprising
an elastic cord to secure said standing stability of said display.

12. a display as recited in claim 10, and further comprising
partial through cut slits to form said hinge bend lines.

13. a display as recited in claim 7, and further comprising
electronically induced lighting.

14. a display as recited in claim 1, and further comprising
erasable marker type receiving surface properties.

15. a display as recited in claim 1, and further comprising
interiorly located cut out portions to match a logo's requirements.

16. a display as recited in claim 1, and further comprising
perimeter edge located cut away portions to match a logo's requirements.

17. a display as recited in claim 7, and further comprising
a polyethylene material.

18. a display as recited in claim 7, and further comprising
a polypropylene material.

19. a display as recited in claim 7, and further comprising
a polyurethane material.

20. a display as recited in claim 1, and further comprising
a notched hand grip located at one distal end of said display.
